(19) United States
(12) Patent Application Publication
(10) Pub. No.: US 2021/0342886 A1
(43) Pub. Date: Nov. 4, 2021

(54) Virtual Advertising Database with Command Input Data

(71) Applicant: David Joseph O'Hanlon, Raleigh, NC (US)

(72) Inventor: David Joseph O'Hanlon, Raleigh, NC (US)

(21) Appl. No.: 17/368,391

(22) Filed: Jul. 6, 2021

Related U.S. Application Data
(63) Continuation-in-part of application No. 15/424,854, filed on Feb. 5, 2017, now abandoned.
(60) Provisional application No. 62/433,790, filed on Dec. 14, 2016.

(51) Int. Cl. G06Q 30/02; G06T 19/00; G06K 9/00

(52) U.S. Cl. CPC G06Q 30/0261; G06K 9/00288; G06T 19/006; G06Q 30/0271

(57) ABSTRACT

Virtual reality devices bring a new type of advertisement preference input command data. The data comes from a source of having your eyes at least partially viewing the sight of a virtual experience. For this reason, and many more, it is very important that this new generation of devices, as they exist and develop, control the advertisements the virtual reality device owners see and react to in the awe struck environment of something new. In order to do this, they will need many different ways to send commands at different points and complexities of advertisements, especially to enjoy the experience of this new device that would otherwise be lost in advertisements that have no ability to coexist without the participants giving orders of what they want to see.

### RELATED APPLICATIONS

This application is a Continuation in Part of and claims benefit to nonprovisional U.S. application Ser. No. 15/424,854, filed Feb. 5, 2017, which further claims benefit of provisional U.S. application Ser. No. 62/433,790, filed Dec. 14, 2016.

### FIELD OF THE INVENTION

The present invention relates to the field of database advertising in virtual reality.

### BACKGROUND OF THE INVENTION

The typical computer uses a mouse or touch-screen to access advertisement objects. These advertisement objects are clicked on by a mouse on the internet. For a very long time, there has been the advancement of this device which has only become a peripheral device by USB for the most part. Although, mainly, how it has been used remains relatively unchanged.

Touch-screen was a big advance and changes were needed by using your fingers to click and zoom in and out of advertisement objects. This was something customers had to adjust to.

There was also the handy stylus which largely emboldened artists and techies to write on the typical tablet or computer screen.

However, now there is a total revamp of tools that are just coming to market. And they haven't scratched the surface with virtual reality and all the advancements in technology. All of the above have been used in the current market for database advertising on the internet. But now we usher in virtual reality and what to do here.

Moreover, many items are on the market in the computer field and advertise digitally. But there are only a few that have major impacts that revolutionize the way we think, see, and act to react to the items of new virtual reality devices.

In the present invention it introduces that virtual reality devices change the realm of what tools you need to complete a task to react to advertisement objects. Each new type of virtual reality gear equips a person the need to understand the new set of rules of operation. This is significant with this generation of device. A hand swipe motion may be picked up by a sensor. And a different sensor that is worn may designate the space by wearing it on your hand or wrist.

For example, these motions connect with the device as a comprehensive command input data preference for advertisements.

A set of further examples therefore starts as simple as passing a hand motion in front of a virtual reality device sensor which may insert an advertising image or make an assist on skipping the image completely. Or perhaps a virtual reality vest that detects excitement by a deep breath during an advertisement. These virtual advertisement preference generating input data can be captured and used for multiple users to deliver better advertisements.

Second, the virtual reality devices will have a new advertisement scheme such as audio and microphone virtual reality or mixed reality and augmented reality. Mixed reality and augmented reality are the integration of virtual reality with that of the real world. Indeed, advertisements need new advertisement preference generating input data to distinguish reactions.

Third, virtual reality devices can still provide more by allowing databases the advertisement schemes preference data to be realized for digital ad iterations to evolve.

However, it is not known to use common movements and devices with a digital ad database analysis of new advertisement preference generating input data with virtual reality devices.

### OBJECTS OF THE INVENTION

It is therefore an object of the present invention to assist computer engineers to use the predicated advertisement preference generating input data motions, button clicks, microphone and speaker directions, mechanical slides, peripheral gadgets motions, such as, computer game golf club motions, three dimensional objects reached outside the virtual reality devices, and stop and move from GPS location to location, to result in the next best available advertisement view by the user.

It is also another object of the present invention to use an algorithm which is a step by step computer process to achieve better advertisements by their average data weight value for multiple users.

It is yet another object of the present invention to have new advertisement command input data in updates for users as virtual reality devices are updated.

It is a further object of the present invention to be as comprehensive a database as possible to mimic the way which human data alteration would supply a digital advertisement to a virtual reality device user.

It is also an object of the present invention to provide the advertisement the user truly desires.

### SUMMARY OF THE INVENTION

In keeping with these objects and others which may become apparent, the present invention includes a system to assist virtual reality device owners the ultimate benefit of the best available advertisement tailored to them by their own advertisement preference generating input data in response to advertisements.

For example, virtual reality advertisement objects are different. They accept advertisement preference generating input data, such as, body gestures, button clicks, GPS location movement, hand swipe motion in front of a sensor, which must be delivered while at least a portion of the consumers eyes are covered by a virtual reality device at least most of the time. So, the experience of using the devices is different and leaves people awe struck.

In the present invention, the advertising images, video, text, and virtual reality, including each of their three-dimensional counter-parts, are either reintroduced or substituted when more user advertisement preference generating input data and system attribute information are analyzed by the database.

Further, the advertising objects need to be cast in a database processor application computer software system to code to target the user as they are compelled to join in participation with the advertisement objects.

It is important that each part of the invention maintain an order which is using mathematical and economic sciences together. As quantitatively and qualitatively, these fundamental sciences create the substantial need for an order to exist to make a new and exciting foundation amongst one another to deliver advertisement objects, have actions upon them, and continue with more closely nearing the perfect performance enabled by algorithms. This creates a fair and equitable set up for all involved in virtual reality advertising and customers as well.

The advertisements in a virtual, augmented, or dictated world, with virtual device outdoor GPS could include those favorite shops we all like to visit. Outside the stores may be the very virtual signage for a sale of hot chocolate and a chocolate croissant. While across the street may be a coffee and a cherry danish. The presentations of these are in an order consistent with enhanced or light processor efficiently operating while also utilizing resourcing home virtual device use.

The example and reason for this is because of the size of the task. The preceding paragraph happens, having an advertiser user store owner stand outside their shop with their virtual reality device. Their virtual reality profile allows them to see the advertisement they choose from a graphic user interface. The database makes the advertisement available in the user profiles of their GPS location in connection to the computer software system database.

This leaves an out-store or outdoors advertisement object that can be seen through the customer profile end of the database within their virtual reality device profile specific to and within the parameters as particular availability to the outdoors customer. There may be more than one special or advertisement outside the place of a business which may change for each individual. And customers who choose one store between friends, help automatically update the database system for others in likes and star reviews for assistance with the next persons' preferred advertisement object.

For example, the advertisement object would then rank one to one hundred or be sighted in some other promotion design within the profiles of the new walker by. The new walker by has their own profile that may sway them toward seeing more acceptable or the same advertisement objects due to likelihood of their own similarities in previously chosen advertisement objects of their customer user profile.

Concerts, sports, and outdoor and indoor events are great places to drop a line to customers' who are likely to want to watch with their virtual reality, augmented, or mixed reality devices adorning their body during the event. This is to chime in on the event becoming more robust by doing so. The virtual device advertiser user setting up the event would be a musician, music rights organizations or sports manager, such as for tennis, drag racing, football, basketball, soccer or the like.

They each choose to send virtual advertising objects for jerseys, line fault replay, concert music, the official offer of winning real or pretend money on bets by established sports gambling statistics offered as informational stats also sharing the events with partners for all these different events, etc. through the advertiser user database to deliver targeted and preferred advertisement objects pertaining to the particular event or specific to and within the parameters of the customer device user.

For example, the event venue could be cordoned off with GPS database event boundary choices, sign in or trackable surround venue chosen by body gesture on a geographical map, pressing buttons on three fencings which can be set up in a database profile for the advertiser user vendor. It's more likely for these musicians and sports events hitting the road to have a chance to have customers' make an authentic biometric data advertisement with even an event sign in on their virtual device having preference generating input data for quick and sometimes impulse buying decisions at the venue within a geographic location.

The advertisement object customer at the event could buy or hit a replay of music, search, function videos, see other live tv sports events across the country than the one they are attending, having gambling stats with bet winnings participation, video game leagues, virtual reality replay, party gathering nights out at lounges, bars, clubs, sports, music concert or complimentary events such as music and football halftime, and movies behind the scenes footage, all while using their virtual devices more happily.

Customer profiles within the context of their virtual reality devices can start an order collectively amongst team events, rivals, and genres for music like jazz and blues musicians having commonality and partnership between events close to showing at the same time which would collectively go to the profiles of the most likely to be interested and find the information highly desirable, while also benefitting the advertiser user in the panalytics of the aggregate.

The quantitative algorithms could be outputting combinations for images in the marketplace wherein the combination runs on a set number of times of showing the images for a set number of images which will reveal the best image to use in a GUI setting of an advertiser user of an enhanced or light processor. Another example would be advertisement price per unit time. During the time the advertisement is out, does it earn more at a low price and high rate of speed showing, or a high price and low rate of speed showing. This becomes an adjustable algorithm that will most likely fluctuate with time.

What can also be done at base level and fixed advertising objects in an application is to use a simple desktop computer database for usage figures. But the database application-data advertising code may replace space between code insertion points in the virtual reality code of microphones and speakers, sensor gloves and display screens, and goggles with other virtual advertisement preference generating input data. Including enhanced or light processors allows the transition in device management.

It is also useful to note that object-oriented programming allows the build and reuse of the advertisement objects to be received, stored, updated, and transmitted again to, within, and from the database. SQL is one such program that allows this type of programming.

Another advertisement object form of creation process is the user advertiser. It can be a said virtual advertisement object creation begins with a user advertiser of at least one database software coded application for advertisement object building for the at least one user advertiser to deliver at least one created at least one advertisement object to at least one first user.

Java® and Java 3D VR programming are two such advertisement object database software used for coding advertisement objects. These also allow for tracking preferences and demographic attributes to be collected, ranked, checked against one another, and delivered.

Marketing properties for demographics, such as age, income, gender, and variations of user information, can be included in tracking and ranking the movement of these groups of population preferential attributes.

Further, the portion of augmented or mixed reality is possible while integrated within at least one portion of virtual reality comprising visible real-world mixing and matching. For instance, the time to display props with a set of theatrical actors can be reduced by introducing a mix of virtual reality theater design with staged reproductions. The football half time could augment fireworks in the music concert in the virtual reality devices of users.

In one embodiment, a virtual reality device and some of the tools for advertisement preference commands are illustrated on the device, and some of those outside it, are all as an example of possibilities.

In another embodiment, a simple no frills database drawing exemplifies the ease of use of a first and second user. This ease spills over as each new user is introduced to become a multiuser platform database. The micro level gives a great introduction.

Alternatively, in another embodiment, a communication network and a network communication module, lie between multiuser and advertiser(s) accessing one another's work through a database that is training the advertisement data to deliver better advertisements to achieve the success of product, information, keyword, demographic or service categories. These categories can also be preferentially tracked to specific users as IP Addresses or other user device authenticity wherein the computer software system uses biometric authenticity, such as but not limited to, voice recognition, finger print identification, facial recognition, eye scans, and keystroke identification as measured during button clicks, hand motions, microphone speech recognition, and GPS location stop and go to name a few of advertisement preference generating input data.

In yet another embodiment, a quantitative remedy or mathematical and economic solution prevail with coupling how successful the qualitative rounds of the advertisement meeting of the two in an overall algorithm process and data analytic metric outline. Although, it is still possible to run on one or the other algorithm, the two operate more precisely with both.

Further, an enhanced or light processor embodiment characterize the full swarm of actions taking place in the comprehensive database with the necessity for efficiency, new creativity and profound impact on events or venues.

Further Still, the embodiment to make the events and venues glow are where the application reader can see and envision the heart pounding moments of music and sports where there is more relevance to virtual reality device data to be used to encompass an unparalleled experience for the sports and music fans.

Finally, is a simple catalogue tab embodiment of a user advertiser making the selections to see if these qualitative attribute selections hold up and will be shown as how strong these qualities are when tested in the virtual reality device world.

A computer software system, having a method of utilizing at least one advertisement preference generating input data within the at least one advertising database application within at least one portion of virtual reality comprising: at least one advertisement object at the at least one comprehensive database is cast to be read by at least one virtual reality device wherein there is an advantage of the at least one first user who inputs at least one virtual advertisement preference generating input data in response to the at least one advertisement object to better their preferences and see an ideal advertisement, having at least one more user using at least one advertisement preference generating input data in response to the at least one advertisement object that is written to the at least one database, wherein the at least one database alters the advertisement preference generating input data to be weighted, such as, by weighing the current advertisement preference generating input data value against the advertisements' average value of the two users of this mathematical process algorithm; wherein writes to the database are updated to readable output data wherein the higher than average value advertisement score updates that advertisement to be delivered to potential clients and averaging the consolidated weight in process for the next round and is also stored in the database storage for the next update of the at least one advertisement preference generating input data using at least this one algorithm; wherein at least one write within the at least one database are updated at least one readable output data as at least one advertisement object code to be cast to at least one of the first users at least one virtual reality device which receives the at least one code and results in the said advantage preferred advertisement.

A computer software system, having utilizing at least one advertisement preference generating input data within a comprehensive advertising database processor application which is executed on an enhanced or light processor to assist the efficiency to intersect the users within a virtual reality comprises to display one or more of the following;

Displaying one to many advertisement objects as flow through the database as cast or fixed by advertiser users graphic user interface profile outputs in an order according to data analytics and attribute preference tracking and ranking for customers' virtual devices;

Displaying one to many advertisement objects as flow through the database as cast or fixed for customers' virtual devices having advertiser users use outputs in an order of a created advertiser user profile and graphic user interface of an data analytic metric system to create advertisements which are to be embedded in rivalry of one another's order of importance and to be in this order as text, 2D, 3D, virtual, augments, mixes, or audible transmitting and receiving delivery;

Displaying one to many advertisement objects as flow through the database as cast or fixed for customers' virtual devices having advertiser users use outputs in an order of a preferences tracking and ranking of one to many advertising objects assigned attributes by an advertiser user or through customers' usage while ordering the preferences track and advertising objects rank;

And with the one or more, identifying the one to many customer advertisement preference generated input data response to the outputs by matching their virtual device biometric authenticity data, and assigning the customer a profile in the database which further identifies customers' updates and likes of similar advertisement objects of one to many customers whom follow suit;

Quantifying or qualifying large group or similar groups metrics at venues through customers' virtual devices use by compiling advertisement preference generating input data through who in advertisement algorithms consistent with enhanced or light processor efficiently operating while also utilizing resourcing home virtual device use;

Wherein one to many virtual reality devices transform, as a result of use of biometric authenticity, creating a new known customers' advantage preferred advertisement object operable specific to and within the parameters of their virtual device, also based on one to many metrics of other customer profiles, which also deliver to an advertiser users' profile to measure advertisements and advertise in the venue data analytics of the aggregate;

A computer software system, utilizing an advertisement preference command input data within an advertising database processor application within a virtual reality comprising;

At least one advertisement object is cast or fixed for at least one first user;

The at least one first user responds with advertisement preference command input data and at least a second user of at least one similar advertisement object follows suit;

An algorithm determines who in answer is better for the advertisement object by processing the at least one advertisement preference command input data;

Wherein at least one of the first users at least one virtual reality device will receive a result of an advantage preferred advertisement object;

A computer software system, having a method of utilizing at least one advertisement preference generating input data within the at least one advertising database application within at least one portion of virtual reality comprising;

At least one database software coded application for advertisement object creation for the at least one user advertiser to deliver at least one partly created at least one advertisement object to at least one first user;

The at least one first user responds with advertisement preference generating input data and at least a second user of at least one similar advertisement object follows suit;

An algorithm determines who in answer is better for the advertisement object by processing the at least one advertisement preference generating input data;

Wherein the advertisement object builds, via writes from the advertising database application, the further attributes and their result is transmitted to database updates to the user advertiser, the user, or stores in the database the advantage preferred advertisement object;

A computer software system, having a method of utilizing at least one advertisement preference generating input data within the at least one advertising database application within at least one portion of virtual reality comprising;

The preference tracking and ranking of at least one advertising object assigned attributes by an advertiser user or through user's usage;

The at least one first user responds with advertisement preference generating input data and at least a second user of at least one similar advertisement object follows suit;

An algorithm determines who in answer is better for the advertisement object by processing the at least one advertisement preference generating input data and checking the advertisement object against the database storage at least one similar advertisement objects' attribute;

Wherein the result of at least one advertisement object and its' attributes rank are assigned at least one database storage and at least one advertisement object is transmitted by higher rank to at least one user virtual device to reiterate the user process which may also transmit results to the user advertiser for information;

A computer software system, having utilizing at least one advertisement preference generating input data within a comprehensive advertising database processor application which is executed on an enhanced or light processor to assist the efficiency to intersect the users within a virtual reality comprises;

Displaying one to many advertisement objects as flow through the database as cast or fixed by virtual device advertiser users having graphic user interface profile outputs in an order according to data analytics and attribute preference tracking and ranking for customers' virtual devices;

Identifying one to many customers' advertisement preference generated input data response to the outputs, wherein matching their virtual device biometric authenticity data and assigning the customers' profiles in the database, further identifies customers' updates and likes of similar advertisement objects after many customers' whom follow suit;

wherein who in answer algorithms are quantifying and qualifying large group events, venues, similar satellite group or out-store metrics of preferred advertisement objects to and within the parameters of the customers' devices and enhanced or light processor efficiency operated data analytics;

The computer software system wherein the computer software system uses global positioning system;

The computer software system wherein the computer software system uses button clicks;

The computer software system wherein the computer software system uses speakers and microphones to hear and speak;

The computer software system wherein the computer software system uses motion sensors detection;

The computer software system wherein the computer software system uses body gestures;

The computer software system wherein the computer software system uses peripheral devices;

The computer software system wherein the computer software system uses biometric authenticity, such as but not limited to, voice recognition, finger print identification, facial recognition, eye scans, and keystroke identification;

The computer software system wherein the at least one first user responds multiple times alone or at random alongside multiple users to train the advertising database processor application;

The computer software system wherein the computer software system uses the value of at least one in-application, music, video or virtual reality purchase of at least one application;

The computer software system wherein the computer software system uses the value of at least one in-application, search, music, video, live tv, movie, video game or virtual reality, and movies behind the scenes footage including product, information, keyword, demographic or service purchase of at least one application;

The computer software system wherein the computer software system uses the value in the event or venue of a geographic location for music or sports wherein there is a virtual advertisement object of at least one in-application, search, music, sports betting and statistics, video, live tv, movie, video game or virtual reality, product, information, service, keyword, or demographic purchase of at least one application;

Wherein located by selecting GPS boundaries, sign in, or trackable boundaries set to a particular event or venue through the advertiser user database graphic user interface profile;

Are desirable outdoor or indoor gatherings, sports or music venues within the advertiser user profile access of the advertisement database processor application for the activity or function outputs within a virtual, augmented, mixed or hearing and listening reality of advertising the music, video, live tv, movie, video game or virtual reality, product, information, service, keyword or demographic;

Presenting in an order the purchase by one to many customers' to those others at the event or venue, genre across events, or advertiser user established output order across events and through the selective profile of each individual;

The computer software system of wherein an advertiser user stands or locates through GPS outside their shop with their virtual reality device, having their virtual reality profile allowing them to see the advertisement they choose from a graphic user interface, the database makes the advertisement available in the user profiles of their GPS location in connection to the computer software system database, they have one to many out-store advertisement objects that can be seen through the customer profile end of the database within their virtual reality device profile specific to and within the parameters as particular availability to their customers;

The computer software system wherein the computer software system has customers' use virtual devices to generate input data of advertisement objects at the event or venues across the country through purchase or hitting a replay of music, search, functioning videos, seeing other live tv sports events, having information on real or pretend gambling stats with bet winnings participation information at games other than the ones being attended, video game leagues, virtual reality replay, also inclusive of smaller partner information from watch party gathering nights out in homes, lounges, bars, clubs, sports, concert or complimentary events such as music and football halftime and other similar genres to sports and music;

The computer software system wherein the computer software system leaves an out-store or outdoors advertisement object that can be seen through the customer profile end of the database specific to and within the parameters as particular availability within their virtual reality device profile for the outdoors customers' benefit;

The computer software system wherein the computer software system is valued at stop, pause, rewind, skip, yes, no, buy, sell, or other quantifying command;

The computer software system wherein the computer software system advertisement preference generation input data algorithms derive results from the input data, such as but not limited to, purchase, bet, play, stop, pause, replay, rewind, skip, yes, no, buy, sell;

The computer software system wherein the advertising database processor application calculation is cost per click;

The computer software system wherein there is at least one in-application purchase of at least one application;

The computer software system wherein there is at least one in-application purchase within at least one application wherein it may also include the purchase of at least one application;

The computer software system wherein there is at least one mixed reality or augmented virtual experiences;

The advertisement objects wherein each text, image, 3-D image, virtual reality, and audible transmitting and receiving delivery, are related objects;

The computer software system wherein each advertisement object is provided or created, such as but not limited to, text, image, 3-D image, virtual reality, and audible transmitting and receiving;

The computer software system wherein the computer software system uses attribute preference tracking and ranking of a keyword;

The computer software system wherein the computer software system uses attribute preference tracking and ranking of a product;

The computer software system wherein the computer software system uses attribute preference tracking and ranking of information;

The computer software system wherein the computer software system uses attribute preference tracking and ranking of a service;

The computer software system wherein the computer software system uses attribute preference tracking and ranking of a demographic;

The computer software system captures new input data wherein the first user responds with or without prompt through at least one command which results with at least one input data wherein there are no additional requirements.

### BRIEF DESCRIPTION OF THE DRAWINGS

The present invention can best be understood in conjunction with the accompanying drawings, in which:

FIG. 1 is a three-dimensional view of various embodiments to use with the preferred embodiment.

FIG. 2 is a no frills flow-chart of the preferred embodiment.

FIG. 3 is a highly detailed flow-chart of a more sophisticated embodiment.

FIG. 4 is a quantitative and qualitative algorithm flow chart.

FIG. 5 is an enhanced or light processor flow chart.

FIG. 6 is a three dimensional view of events and venues.

FIG. 7 is a very basic for explanation of more complex virtual reality cataloging tabs in a qualitative advertising process assignment.

### DETAILED DESCRIPTION OF THE INVENTION

It is well known that experienced computer programmers use varied elements in order to work out advertisements for the internet for people to find new things and for advertisements to reach deeper and deeper by exposure to the kinds of things we like. It may be one of the most common things that people enjoy less because of the detached senses of the cell phone or computer tablet advertisement object.

However, the sense of reaction to virtual reality devices is so new that people are excited by the added content. That is why this invention is so important to allow the ability to switch to this new generation of product with new advertisement preference generating input data with classes such as product, information, or service.

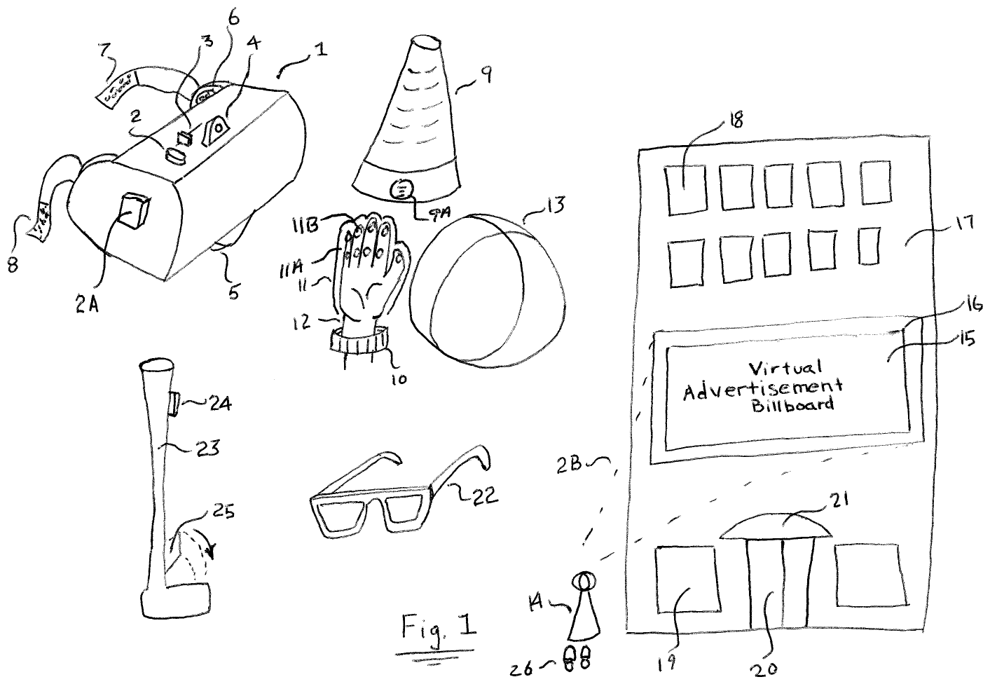

FIG. 1 is virtual reality device 1 of an eye cover having a biometric authenticity eye scanner in the inner portion of where the back of the head is strapped by hook fasteners 7 and loop fasteners 8 with the face and eyes pointing directly forward, button 2 generating the action of visible virtual button or click on target advertisement preference generating the input data, GPS unit command 2A advertisement preference generating input data when eyesight has physically moved to within reach of the target, while slide command or generator 3, motion sensor command or generator 4, microphone command or generator of novel input data having biometric authenticity voice recognition 5, audio advertisement 6, having all in common advertisement preferences generating input data of a virtual reality device acting as a tool of enhanced or light processors on an advertisement to better the computer software system quantitative and qualitative algorithms with a uniquely targeting preferred advertisement object and data analytics, speaker advertisement 9 outputs the answer to a question and further the computer software system is for when this particular use of the at least one first user responding multiple times alone or at random alongside multiple users to train the advertising database processor application through speech at microphone 9A, GPS or motion peripheral device command bracelet 10 is also computer software system located near the physical target of an advertisement object, hand 11, wearing a sensor glove 11A with Sensors 11B as an example of how body gestures are gathered and wrist 12, reach ball 13, as located on a cone shape 14, with GPS located foot prints command to stand in 26, to show how as a point of reference of how a virtual billboard advertisement 15, with border 16, may look when the user reaches a location within a virtual reality devices portion of a viewing sight 2B, of building 17, with windows 18 and 19, door 20, and canopy 21. Virtual, augmented, mixed, reality glasses 22 may be used. Golf club peripheral device 23 has button command or generator of an advertisement preference generating input data 24 and open club face range of motion command or generator 25.

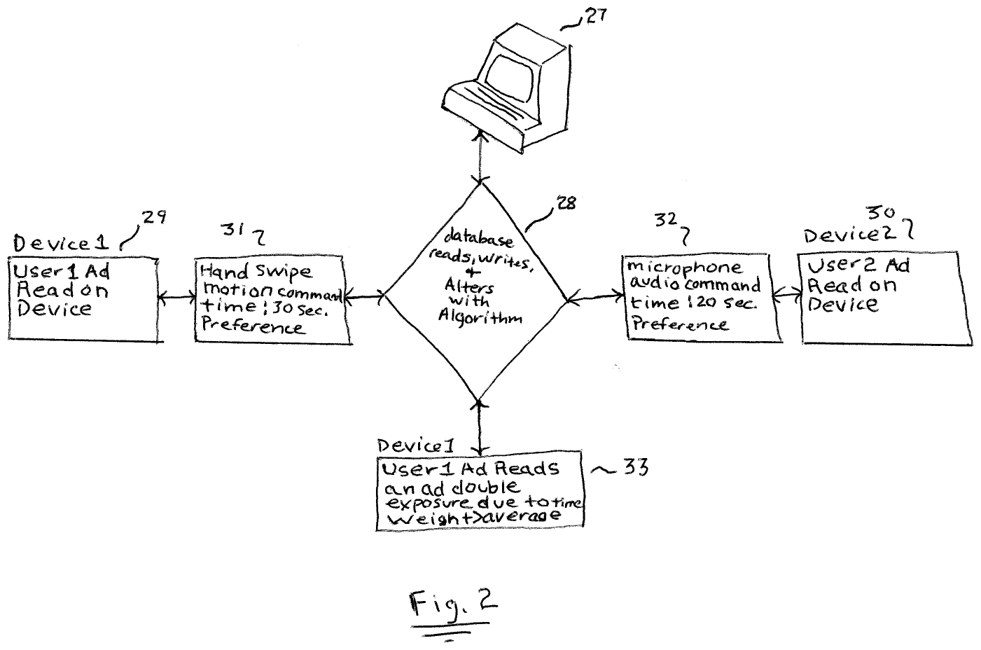

FIG. 2 has advertiser user GUI input 27, reaching virtual reality devices that read data at 29 and 30, users making decision having advertisement preference generating input data at 31 referring back to FIG. 1 and number 4 a motion sensor command or generator of an advertisement preference generating input data wherein a hand swipe motion in front of the devices motion sensor thereof for 00:30 seconds of watching an advertisement, and 32 which is a microphone command or generator having advertisement preference generating input data with voice biometric authenticity for 00.20 second advertisement participation, referring back to FIG. 1 and number 5 for the command or generator of a preference microphone origin, altered 28 in comprehensive database, and new advertisement read for new reaction to the virtual reality device 33 due to time average weight of 00:25 greater 00:30 seconds as in the quantitative algorithm process.

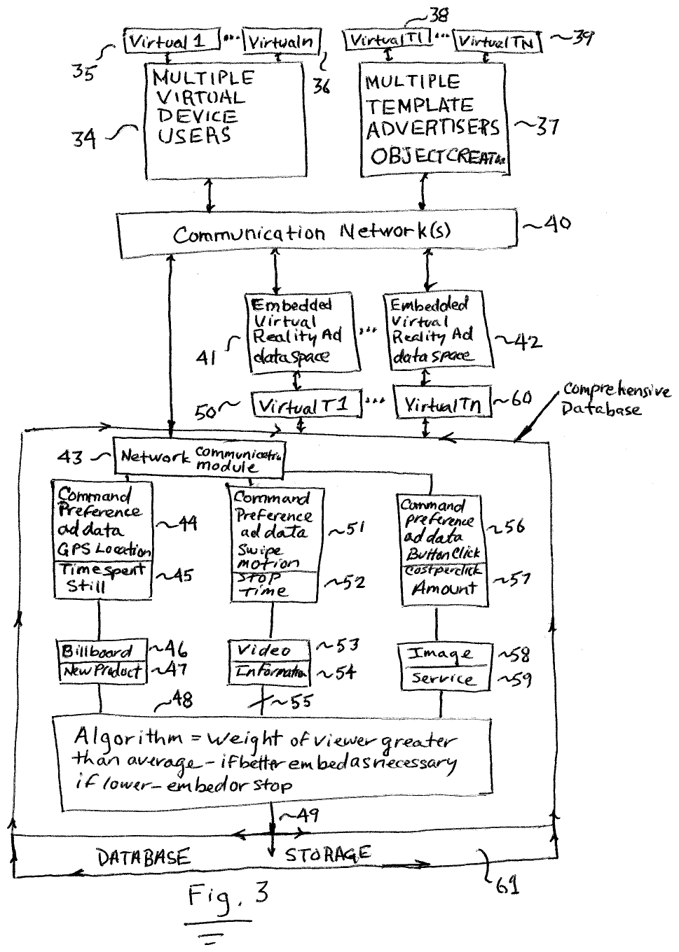

FIG. 3 has multiple virtual device users of enhanced or light processors 34 from profiles of users virtual 1 35 to virtual n 36 and multiple creative advertisement object user advertiser database application user profiles that do not coincide with profiles virtual 1 to virtual n with those of GUI of enhanced or light processors 37 from virtual advertiser profile user T1 38 to virtual Tn 39. A communication network allows all data to flow from 40 and through the network communication module 43, such as, flowing from advertisement object creation 37 to virtual marketplace ad space embedded at virtual reality ad data space of virtual reality program components 41 and 42 for virtual advertisers, virtual T1 50 to Virtual Tn 60, which virtual advertisements are viewed and acted upon through readable database storage 61 at the comprehensive database. The virtual advertisements as embedded 41 to 42, are shown as an advertisement preference generating input data GPS 44 time spent at location 45, viewing a virtual billboard 46 of a new product 47 processed by an algorithm 48 for sending to database storage only 61 or also to embed space again at 41 to 42 as the type of tracked product class matches virtual T1 to Virtual Tn of Virtual 1 device to Virtual n device. Advertisement preference command input data swipe motion 51 has an information 54 video 53 stop time 52 that is stopped at 55 as a low algorithm score and sent 49 to database storage where it is earmarked or understood to be ready to return to the marketplace once other information videos with similar qualitative attributes fall behind and the originally removed advertisement located to storage now over qualifies and quantifies algorithm scores and is more attractive once again for the virtual reality marketplace which reenters the information advertisement object into the computer software advertisement system which is operating efficiently on enhanced or light processors. Advertisement preference generating input data button click 56 is a cost per click ad of an amount 57 and also an image ad 58 which is a tracked service 59 for redistribution 49 to the marketplace at virtual T1 50 to Virtual Tn 60 of data space 41 and 42 of virtual reality device users 34 at virtual 1 device 35 to virtual n device 36 which do not coincide 1 to n.

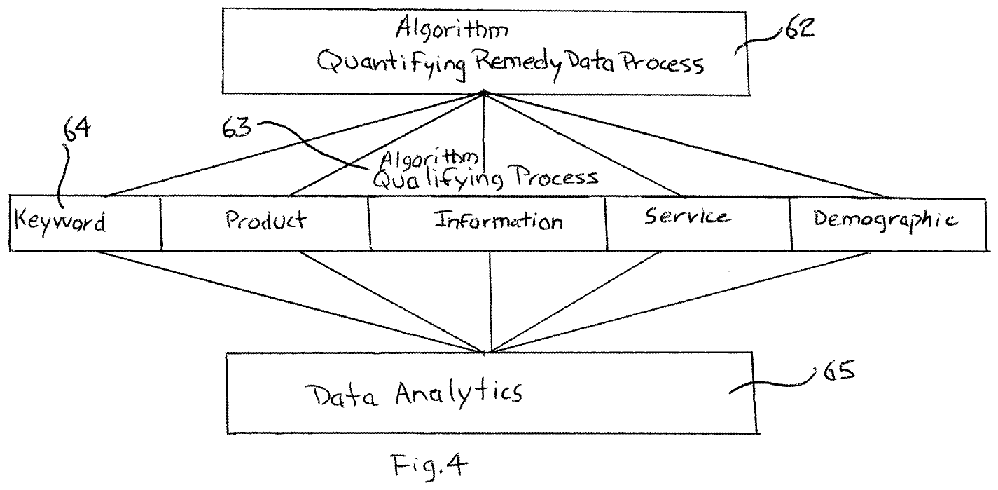

FIG. 4 An algorithm quantifying remedy data process 62 reveals how substantial an advertisement is working quantitatively wherein 63 an algorithm qualifying process such as if the offer is 64 at least one attribute keyword, product, information, service, or demographic and is that offer 64 still at play in the system which can help whether or not it has reentry and clarifies the total data analytics 65.

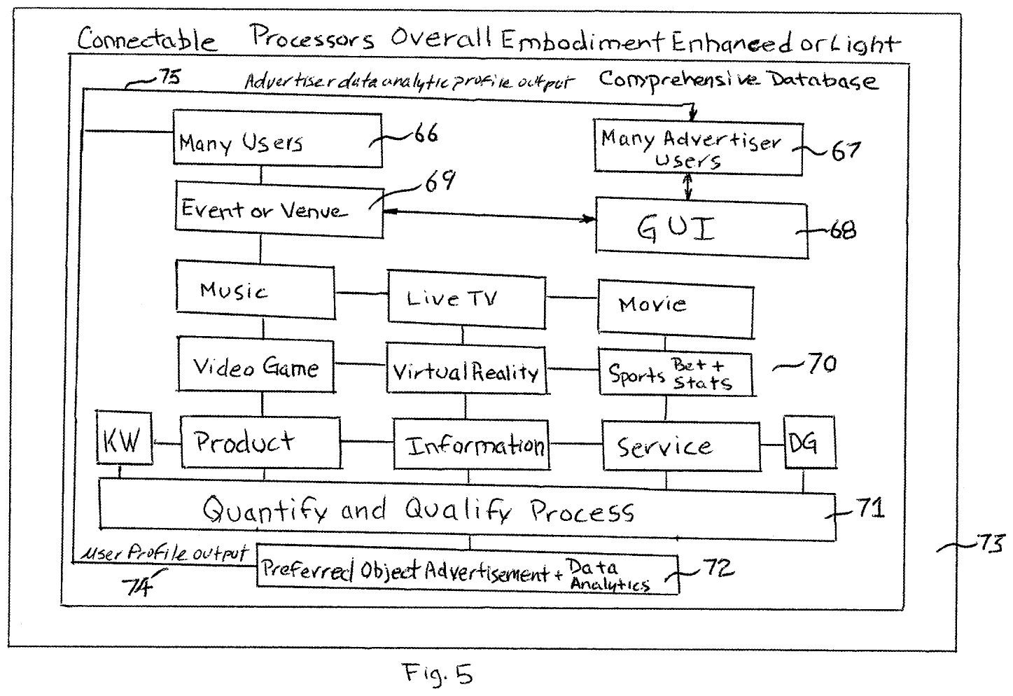

FIG. 5 Many virtual reality device users 66 having profiles or sign in and many advertiser users having profile or sign on their virtual reality device in 67, create in a GUI 68 the advertisements for an event or venue 69 which is music concerts or sports events and the like, etc. wherein some of the items can be purchased like music or genre of music 70 at the concert event or at similar concert events 69 or sports betting and statistics 70 at a sporting event or throughout the country while at that event 69 which is really good for any qualitative keyword, product, information, service or demographic offering which is assigned 70 and quantified and qualified in a process 71 to create preferred advertisement object and data analytics in a virtual device environment 72 on connectable enhanced or light processors in the overall embodiment 73 wherein the user profile output 74 for many users virtual reality devices 66 is the preferred advertisement object 72 and the advertiser sees what is working in a data analytic profile output to their virtual reality devices 75 at 67 and 68.

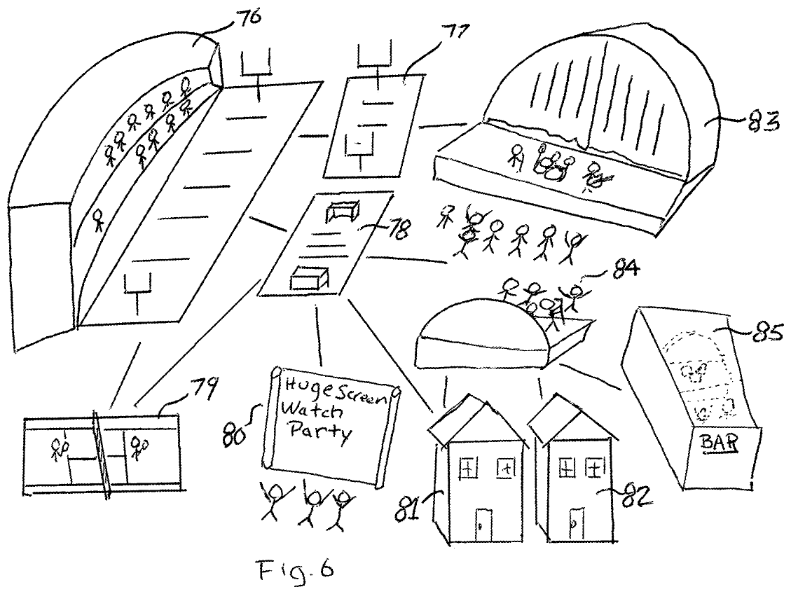

FIG. 6 A football stadium event full of sports fans have virtual reality devices and watch the game from their seats 76 wherein, referring back to FIG. 5 number 70 the betting and statistical information is available to them at the event and similar events across the country 77 crossing over to other sports of interest are at least some of the games such as soccer betting and statistics at 78, tennis 79 can be seen and have a live tv replay of a line fault, referring back to FIG. 5 number 70 live tv is information and huge screen watch party can get the same event features at their geographic location if one sets it up 80 having home location fans at 81 and 82 who may be interest in live concerts 83 where live event fans using virtual devices to purchase t-shirts and music at the show 84 which may also be shown at this smaller event or even less than that a bar stage having a music or sports event 85 and a complimentary football 76 and music tradition 83 is also useful with virtual reality devices.

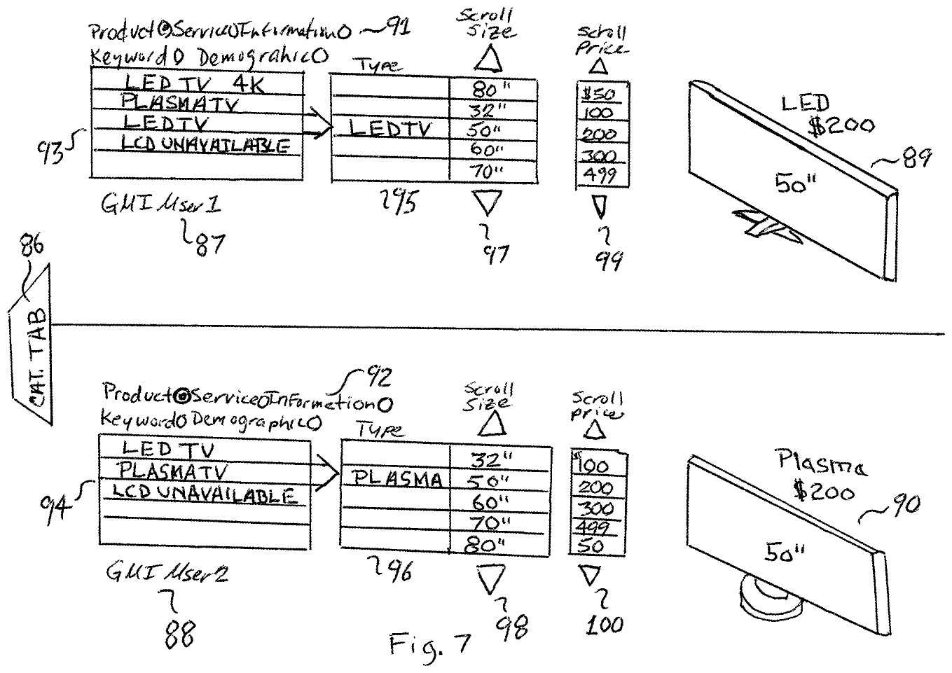

FIG. 7 The virtual reality device Cataloguing Tab 86 of a qualitative algorithm selection for a GUI user 1 87 and GUI user 2 88 both having 3-dimensional TV for the market. One is a fifty-inch LED TV for two hundred dollars 89 and the other is a fifty-inch Plasma TV for two hundred dollars 90 which both users have selected using their virtual reality device a product at 91 and 92, the choices of TV at 93 are all available but no one is buying the LCD television so that is listed as unavailable 94, television type choices which are virtual 95 and 96 are made as well as the scroll size 97 and 98 and the scroll price 99 and 100 the main product now has three associated attributes which will be analyzed until unavailable or wildly popular at 95 through 100.

I claim:

1. A computer software system, having utilizing at least one advertisement preference generating input data within a comprehensive advertising database processor application which is executed on an enhanced or light processor to assist the efficiency to intersect the users within a virtual reality comprises:
displaying one to many advertisement objects as flow through the database as cast or fixed by virtual device advertiser users having graphic user interface profile outputs in an order according to data analytics and attribute preference tracking and ranking for customers' virtual devices;
identifying one to many customers' advertisement preference generated input data response to the outputs, wherein matching their virtual device biometric authenticity data and assigning the customers' profiles in the database, further identifies customers' updates and likes of similar advertisement objects after many customers' whom follow suit;
wherein who in answer algorithms are quantifying and qualifying large group events, venues, similar satellite group or out-store metrics of preferred advertisement objects to and within the parameters of the customers' devices and enhanced or light processor efficiency operated data analytics.

2. The computer software system of claim 1 wherein the computer software system uses global positioning system.

3. The computer software system of claim 1 wherein the computer software system uses button clicks.

4. The computer software system of claim 1 wherein the computer software system uses speakers and microphones to hear and speak.

5. The computer software system of claim 1 wherein the computer software system uses motion sensors detection.

6. The computer software system of claim 1 wherein the computer software system uses body gestures.

7. The computer software system of claim 1 wherein the computer software system uses biometric authenticity, such as but not limited to, voice recognition, finger print identification, facial recognition, eye scans, and keystroke identification.

8. The computer software system of claim 1 wherein the at least one first user responds multiple times alone or at random alongside multiple users to train the advertising database processor application.

9. The computer software system of claim 1 wherein the computer software system uses the value of at least one in-application, music, video, live tv, movie, video game or virtual reality, and movies behind the scenes footage including product, information, keyword, demographic or service purchase of at least one application.

10. The computer software system of claim 1 wherein the computer software system uses the value in the event or venue of a geographic location for music or sports wherein there is a virtual advertisement object of at least one in-application, search, music, sports betting and statistics, video, live tv, movie, video game or virtual reality, product, information, service, keyword, or demographic purchase of at least one application. 11 The computer software system of claim 1 wherein the computer software system has customers' use virtual devices to generate input data of advertisement objects at the event or venues across the country through purchase or hitting a replay of music, search, functioning videos, seeing other live tv sports events, having information on real or pretend gambling stats with bet winnings participation information at games other than the ones being attended, video game leagues, virtual reality replay, also inclusive of smaller partner information from watch party gathering nights out in homes, lounges, bars, clubs, sports, concert or complimentary events such as music and football halftime and other similar genres to sports and music.

12. The computer software system of claim 1 wherein the computer software system leaves an out-store or outdoors advertisement object that can be seen through the customer profile end of the database specific to and within the parameters as particular availability within their virtual reality device profile for the outdoors customers' benefit.

13. The computer software system of claim 1 wherein the computer software system advertisement preference generation input data algorithms derive results from the input data, such as but not limited to, purchase, bet, play, stop, pause, replay, rewind, skip, yes, no, buy, sell.

14. The computer software system of claim 1 wherein the advertising database processor application calculation is cost per click.

15. The computer software system as in claim 1 wherein there is at least one in-application purchase within at least one application wherein it may also include the purchase of at least one application.

16. The computer software system of claim 1 wherein there is at least one mixed reality or augmented virtual experiences.

17. The computer software system of claim 1 wherein the computer software system uses attribute preference tracking and ranking of a keyword.

18. The computer software system of claim 1 wherein the computer software system uses attribute preference tracking and ranking of a product.

19. The computer software system of claim 1 wherein the computer software system uses attribute preference tracking and ranking of information.

20. The computer software system of claim 1 wherein the computer software system uses attribute preference tracking and ranking of a service.

21. The computer software system of claim 1 wherein the computer software system uses attribute preference tracking and ranking of a demographic.

22. The computer software system of claim 1 captures new input data wherein the first user responds with or without prompt through at least one command which results with at least one input data wherein there are no additional requirements.
